(19) United States
(12) Patent Application Publication
(10) Pub. No.: US 2026/0127497 A1
(43) Pub. Date: May 7, 2026

(54) SYSTEMS AND APPARATUS TO TRAIN MACHINE LEARNING MODELS FOR ITEM CODING

(71) Applicant: Nielsen Consumer LLC, Chicago, IL (US)

(72) Inventors: Maria Leyva Vallina, Rioseco (ES); David Jiménez Cabello, Lupiana (ES)

(21) Appl. No.: 19/379,335

(22) Filed: Nov. 4, 2025

Related U.S. Application Data
(60) Provisional application No. 63/716,055, filed on Nov. 4, 2024.

(51) Int. Cl. G06N 20/00; G06Q 30/0601

(52) U.S. Cl. CPC G06N 20/00; G06Q 30/0627

(57) ABSTRACT

Systems and apparatus to train machine learning models for item coding are disclosed. An example apparatus to pretrain a machine learning model for item coding includes machine-readable instructions; and at least one programmable circuit to at least one of instantiate or execute the machine-readable instructions to generate a data structure based on a product description, the data structure defining a hierarchy of product characteristics; train a machine learning (ML) model based on the data structure and using causal training; and generate, based on the causal training, a pre-trained ML model to output predicted product characteristics for item coding.

### RELATED APPLICATION

This patent claims the benefit of U.S. Provisional Ser. No. 63/716,055 , which was filed on Nov. 4, 2024. U.S. Provisional Ser. No. 63/716,055 is hereby incorporated herein by reference in its entirety. Priority to U.S. Provisional Ser. No. 63/716,055 is hereby claimed.

### FIELD OF THE DISCLOSURE

This disclosure relates generally to artificial intelligence and, more particularly, to systems and apparatus to train machine learning models for item coding

### BACKGROUND

Item coding includes classifying products based on product characteristics such as brand, product category, and size. Coherency between the product characteristics assigned to a product is indicative of accuracy of an automated item coding process.

### BRIEF DESCRIPTION OF THE DRAWINGS

FIG. 1 is a block diagram of an example system including model pretraining circuitry to pretrain a machine learning model, model tuning circuitry to tune the machine learning model, and example item coding circuitry to execute the machine learning model to perform item coding.

FIG. 2 is a block diagram of an example implementation of the model pretraining circuitry 108 of FIG. 1.

FIG. 3 illustrates an example task in connection with pretraining the machine learning model of FIG. 1.

FIG. 4 is a block diagram of an example implementation of the model tuning circuitry 108 of FIG. 1.

FIG. 5 is a block diagram of an example implementation of the item coding circuitry 108 of FIG. 1.

FIG. 6 is a flowchart representative of example machine readable instructions and/or example operations that may be executed, instantiated, and/or performed by example programmable circuitry to implement the model pretraining circuitry of FIG. 2.

FIG. 7 is a flowchart representative of example machine readable instructions and/or example operations that may be executed, instantiated, and/or performed by example programmable circuitry to implement the model tuning circuitry of FIG. 4.

FIG. 8 is a flowchart representative of example machine readable instructions and/or example operations that may be executed, instantiated, and/or performed by example programmable circuitry to implement the item coding circuitry of FIG. 5.

FIG. 9 is a block diagram of an example processing platform including programmable circuitry structured to execute, instantiate, and/or perform the example machine readable instructions and/or perform the example operations of FIG. 6 to implement the model pretraining circuitry of FIG. 2.

FIG. 10 is a block diagram of an example processing platform including programmable circuitry structured to execute, instantiate, and/or perform the example machine readable instructions and/or perform the example operations of FIG. 7 to implement the model tuning circuitry of FIG. 4.

FIG. 11 is a block diagram of an example processing platform including programmable circuitry structured to execute, instantiate, and/or perform the example machine readable instructions and/or perform the example operations of FIG. 8 to implement the item coding circuitry of FIG. 5.

In general, the same reference numbers will be used throughout the drawing(s) and accompanying written description to refer to the same or like parts. The figures are not necessarily to scale.

### DETAILED DESCRIPTION

As discussed above, item coding includes classifying products based on product characteristics such as brand, product category, and size.

Coherency between the product characteristics is indicative of accuracy of an automated item coding process. Known item coding models use independent classifiers (e.g., machine learning models) to identify each product characteristic, which can lead to incoherent results between respective product characteristics assigned to a product. For instance, because of the use of separate or independent classifiers, an item coding model attempting to classify a soft drink may predict that the product brand of the soft drink is Coca-Cola® and the manufacturer is Pepsi®. Thus, known item coding models may not accurately capture patterns and relationships between product characteristics during the classification process because of the lack of interdependence in execution of the models. However, recognizing sequential dependencies (e.g., an order of information or hierarchy) in connection with product characteristics is important in item coding to accurately predict the product characteristics.

Disclosed herein are example systems and apparatus for training (e.g., pretraining) a machine learning model that provides coherency with respect to classifying characteristics of a product. Examples disclosed herein provide a generative model for natural language processing, such as an autoregressive transformer model, where the model is pretrained to consider patterns and relationships when predicting product characteristics for item coding based on product attribute input data. An example machine learning (ML) model disclosed herein has causal structures or properties in that the model uses previous prediction(s) of product characteristic(s) for a product to influence subsequent prediction(s) of product characteristic(s) for the product. As a result, the example ML model disclosed herein promotes coherency in identifying product characteristics based on product attribute(s) or product description(s) received as input data. The product attribute(s) or description(s) can be identified from, for example, an image of a receipt or an image of a product.

Examples disclosed herein use causal pretraining to promote coherency in automated item coding by pretraining the model to understand language nuances (e.g., apple for food versus Apple® for consumer electronics) and product characteristics and corresponding values that apply to different product descriptions (e.g., product characteristics such as brand and liquid volume for a soft drink). In examples disclosed herein, the use of an autoregressive model provides for improved accuracy and coherency in predicting product characteristics for item coding as compared to use of separate classifiers for predicting product characteristics. The example model disclosed herein maintains coherency in predicting product characteristics across a hierarchy (e.g., supergroup, item group, brand) and exhibits improved consistency as compared to models that independently predict characteristics and/or as compared to autoencoder models. Examples disclosed herein use causal pretraining to generate a model that accounts for sequential dependencies between product characteristics (e.g., product type, manufacturer, product size). The pretrained model disclosed herein can be fine-tuned for specific datasets and/or specific item coding tasks. As a result, examples disclosed herein provide for coherency in predicting product characteristics for item coding.

Examples disclosed herein are directed to improvement(s) in the operation of a machine such as a computer as compared to the use of separate classifiers for predicting product characteristics for item coding. Rather than executing multiple models that separately predict product characteristics and, thus, may result incoherent overall results (e.g., identifying a product category as a house appliance and product type as a beverage), examples disclosed herein provide a pretrained autoregressive model built on domain knowledge that accounts for sequential dependencies in product characteristics (e.g., if a product type is a beverage, then product size will be liquid volume). Examples disclosed herein reduce computational resources as compared to executing and maintaining multiple models that separately classify product characteristics. Thus, the causal nature of the disclosed ML model provides for increased efficiency in operation of a machine such as a computer as compared to executing multiple classifiers in connection with, for example, natural language processing for product item coding.

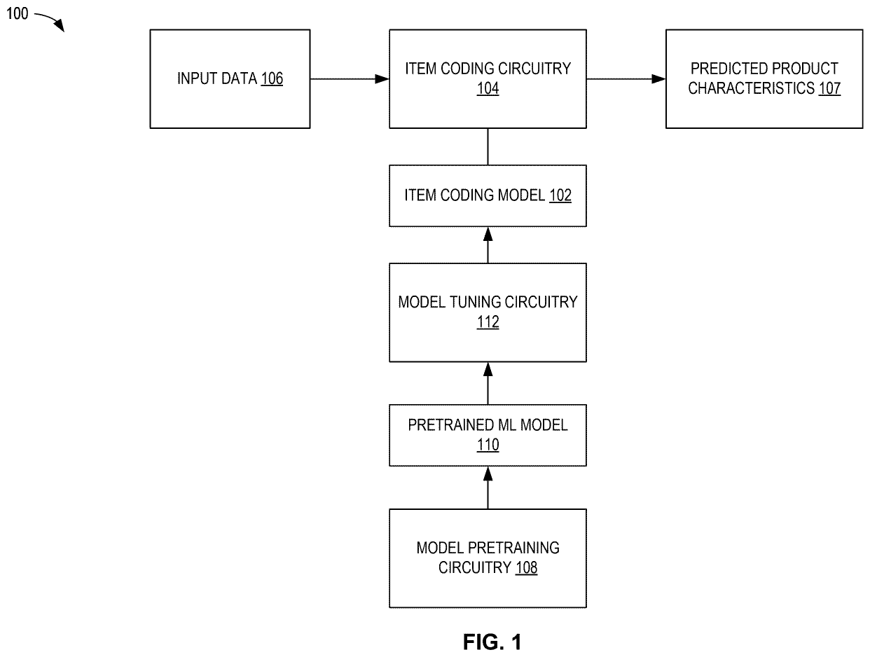

FIG. 1 is a block diagram of an example system 100 to generate and execute a machine learning (ML) model 102 that considers sequential dependencies when predicting characteristics of a product based on product descriptions or attributes for item coding. The ML model 102, which will be referred to hereinafter as the item coding model 102, can be a generative model such as an autoregressive transformer model. In the example of FIG. 1, item coding circuitry 104 executes the item coding model 102 using input data 106. The input data 106 can include text extracted from, for example, a receipt for a product (e.g., “Coca-Cola®, 330 mL”) or an image of the product (e.g., an image of a soft drink bottle). As a result of execution of the item coding model 102, the item coding circuitry 104 recognizes the product description and outputs predicted product characteristics 107 for the product associated with the input data 106 (e.g., using natural language processing). The product characteristics for item coding can include, for example, brand, category, and volume.

In the example of FIG. 1, the item coding model 102 is pretrained to account for information dependency in the context of item coding classifications when predicting the product characteristics for item coding. The example system 100 of FIG. 1 includes model pretraining circuitry 108. The model pretraining circuitry 108 trains (e.g., pretrains) a ML model, such as an autoregressive model, using datasets including product descriptions and associated product characteristics for item coding. As a result, the model pretraining circuitry 108 generates a pretrained ML model 110 that is based a causal structure (e.g., uses prior predictions to generate subsequent predictions) and uses natural language processing to generate outputs in the context of item coding.

The example system 100 includes model tuning circuitry 112. The model tuning circuitry 112 fine tunes the pretrained ML model 110 for particular datasets, particular item coding tasks, etc. For example, the model tuning circuitry 112 can fine tune the pretrained ML model 110 using a dataset that is particular to a set of products and/or product characteristics associated with a manufacturer and/or a retailer. As a result of the fine tuning performed by the model tuning circuitry 112, the item coding model 102 is generated for use by the item coding circuitry 104 when analyzing the input data 106 and predicting the corresponding product characteristics 107 for item coding.

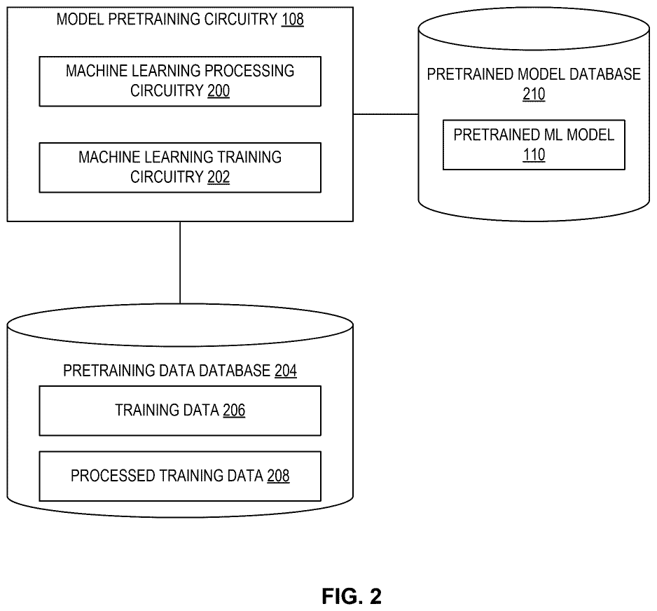

FIG. 2 is a block diagram of an example implementation of the model pretraining circuitry 108 of FIG. 1 to pretrain a machine learning (ML) model to generate the pretrained ML model 110 for item coding. The model pretraining circuitry 108 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the model pretraining circuitry 108 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

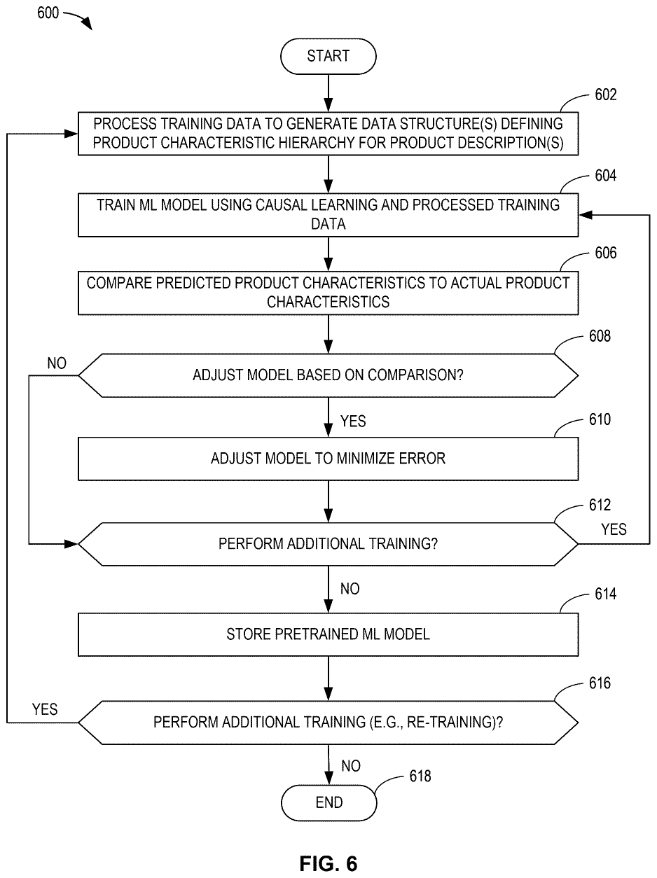

The example model pretraining circuitry 108 of FIG. 2 includes machine learning processing circuitry 200 and machine learning training circuitry 202. In some examples, the ML processing circuitry 200 is instantiated by programmable circuitry executing ML processing instructions and/or configured to perform operations such as those represented by the flowchart of FIG. 6. In some examples, the ML training circuitry 202 is instantiated by programmable circuitry executing ML training instructions and/or configured to perform operations such as those represented by the flowchart of FIG. 6.

The model pretraining circuitry 108 has access to an example pretraining data database 204 (where the pretraining data database 204 can be local or remote to the model pretraining circuitry 108). The example ML training circuitry 202 performs training of an ML model (e.g., an autoregressive model) implemented by the ML processing circuitry 200 using training data 206 in the pretraining data database 204. In some examples, the ML model that is pretrained is from the Pythia suite, which includes large language models (LLMs) of different sizes. However, other autoregressive models or encoder-decoder architectures can be used to generate the pretrained ML model 110.

In the example of FIG. 2, the training data 206 includes product descriptions or attributes and associated product characteristics for item coding. To train an ML model for item coding, the ML processing circuitry 200 preprocesses the training data 206 to define data structures based on product characteristics and relationships therebetween. In a ML model having causal properties, such as an autoregressive model, a token is a data unit (e.g., a word) that the model predicts, where subsequent tokens are predicted based on the prior or parent token prediction(s). In the example FIG. 2, one or more token(s) can correspond to the input data in the form of product description(s). The ML model uses the token(s) corresponding to the input data to predict subsequent tokens, which correspond to the product characteristics for item coding. Thus, for a given product description, the ML model sequentially predicts respective product characteristics (e.g., brand, volume) based on previously generated predictions. To facilitate training of the ML model for item coding, the ML processing circuitry 200 converts the (e.g., unstructured) training data 206 into the following data structure (e.g., token data structure) for a given product description and corresponding known product characteristics:
product_description [SEP] char_name1: char_val1 [SEP] char_name2: char_val2 [SEP] . . . char_name(n): char_val(n) [EOS]
   In the aforementioned example data structure, the product description corresponds to, for example, text extracted from a receipt or an image of a product (e.g., input token(s)). In the aforementioned example data structure [SEP] is a separator token; “char_name(n)” is a token having a value “char_val(n)” where (n) corresponds to a sequence or order of the product characteristic in a hierarchy of product characteristics; and EOS represents an end-of-sentence token. Thus, the data structure defines the product characteristic hierarchy for the product characteristic. For example, when the training data 206 includes the description “Coca-Cola 330 ml” and corresponding product characteristics brand, category, and volume, the ML processing circuitry 200 generates the following data structure or training sample:
Coca-Cola 330 ml [SEP] BRAND: Coca-Cola [SEP] [CATEGORY]: Beverages [SEP] VOLUME: 330 ml [EOS]
   In the example of FIG. 2, the ML processing circuitry 200 generates the data structures for product descriptions and associated product characteristics in the training data 206 and stores the data structures in the pretraining data database 204 as processed training data 208.

In the example of FIG. 2, the ML training circuitry 202 trains the ML model (e.g., an autoregressive model) using the processed training data 208. In particular, the ML training circuitry 202 trains the ML model to learn a next-token-prediction task, where for a given product description, the model uses predicted token(s) as output(s) and expected token(s) (e.g., the next token in the input) as target(s). The ML training circuitry 202 can optimize the ML model during training using, for example, a Cross-Entropy loss function, to minimize errors between the predicted product characteristics generated during training in view of actual product characteristics. As a result of the training, the ML training circuitry 202 generates the pretrained ML model 110, which is stored in a pretrained model database 210.

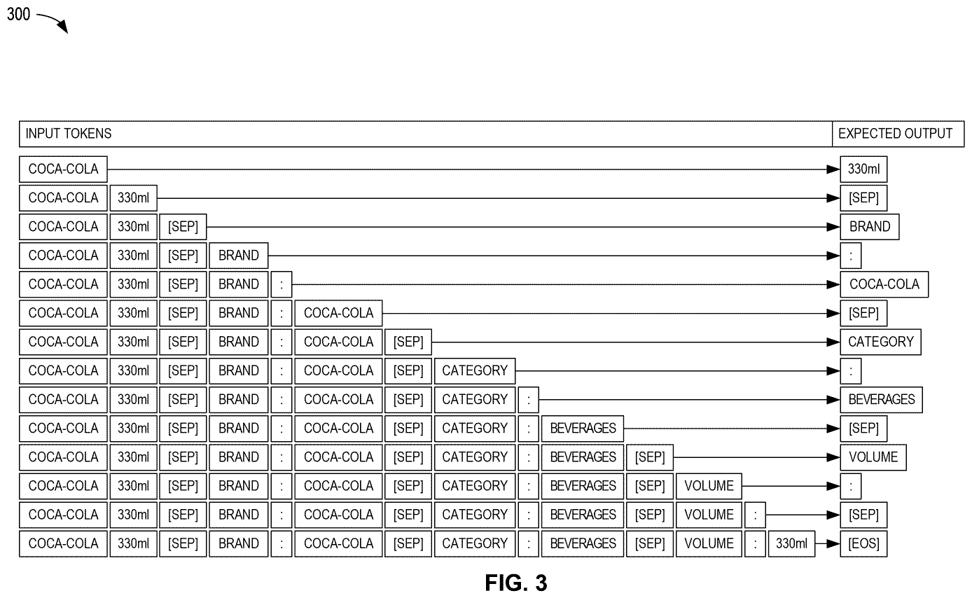

FIG. 3 illustrates an example next-token-prediction task 300 that can be used by the ML training circuitry 202 of FIG. 2 to train an ML model (e.g., an autoregressive model) to generate the pretrained ML model 110. The example next-token-prediction task 300 can be used to perform causal training the ML model. FIG. 3 illustrates the next-token-prediction task 300 for the product description “Coca-Cola 330 ml.” As shown in FIG. 3, the product description is provided as input token(s). The ML model is then trained to predict characteristics associated with the product description (e.g., brand, category, volume) based on a product characteristic hierarchy (also referred to as a product characteristic sequence or order of information). The product characteristic hierarchy is structured so that the ML model learns the characteristics in a top-down approach such that product characteristics defined earlier in the hierarchy are predicted before product characteristics defined later in the hierarchy (e.g., a coarse-grained to fine-grained sequence of product characteristics, a higher level/general to more complex sequence of product characteristics). For example, in FIG. 3, the ML model learns product characteristics such as brand and category before fine-grained characteristics such as volume. The prediction for product characteristic “brand” is used as an input to influence the prediction of the product characteristic “category,” and the predictions of the brand and category product characteristics are used as inputs to predict the product characteristic “volume.” In some examples, the fine-grained characteristics may be independent of other product characteristics in the hierarchy (e.g., characteristics such as product volume or flavor may be independent of manufacturer). Thus, in the example of FIG. 3, the more fine-grained for complex product characteristics are learned last in the sequence of product characteristics to increase a likelihood that those product characteristics are predicted more accurately based on the influence of prior predictions.

For example, in FIG. 3, the ML model is trained using the example next-token-prediction task 300 to learn that the product characteristic “brand” corresponds to “Coca-Cola.” The model is then trained to use the brand as an input token for predicting the next token (e.g., the next product characteristic, in this example, “category”). The ML model is trained to learn that the product characteristic “category” corresponds to “beverages.” Subsequently, the ML model learns the product characteristic “volume” as “330 ml” using the parent product characteristics of brand (“Coca-Cola”) and category (“beverages”) as input tokens.

Although the hierarchy or sequence of product characteristics in FIG. 3 includes brand, category, and volume, other product characteristics and/or product characteristic hierarchies can be used to train the ML model.

For example, the processed training data 208 of FIG. 2 can include the product characteristics in order of “supergroup,” “group,” “module,” and “brand” (e.g., perishable food (supergroup), fresh food (group), fruit (module), Del Monte Foods® (brand)). As another example, the processed training data 208 can include a hierarchy of product characteristics defined as “brand,” “subbrand,” “category,” and “weight.” As another example, the processed training data 208 can include a hierarchy of product characteristics defined as “department,” “supercategory,” “subcategory,” “segment,” and “brand.” In some examples, not every product characteristic may be relevant to a product; in such examples, a value of “not applicable” can be assigned to a product characteristic for a particular product in the processed training data 208. Thus, the ML training circuitry 202 of FIG. 2 trains (e.g., pretrains) the ML model using different data structures for different product descriptions.

The ML training circuitry 202 of FIG. 2 pretrains the ML model to predict product characteristics across products and different product characteristic hierarchies to generate the pretrained ML model 110. As disclosed in connection with FIG. 3, the ML training circuitry 202 trains the ML model to prioritize predicting higher level or more general product characteristics (e.g., predict brand, then predict category) before predicting more complex product characteristics such as volume or flavor. For example, when the product characteristics to be predicted follow a hierarchical order such as supergroup, group and module (where a group is associated with a single supergroup and a module is associated a single group), the ML training circuitry 202 trains the ML model to first predict the product characteristic at the top of the hierarchy (supergroup, in this example), which is usually more coarse-grained and, thus, more likely to be correctly predicted by the ML. The ML training circuitry 202 trains the ML model to predict the remaining product characteristics in the order of the hierarchy (e.g., predict group, then predict module). The product characteristics predicted earlier in the hierarchy by the ML model influence the product characteristics predicted later in the hierarchy. Thus, in the example product characteristic hierarchy “supergroup-group-module,” the prediction of the supergroup will influence the prediction of the group, and the predictions of the supergroup and group will influence the prediction of the module by the ML model. The use of the prior prediction(s) guides the ML model in predicting other product characteristics and results in a higher probability of correct predictions.

When an ML model correctly predicts higher-level or coarse-grained characteristics (e.g., supergroup), then those predictions are more likely to lead to more informed prediction(s) of fine-grained product characteristics (e.g., volume) in the hierarchy. As a result, product characteristic predictions for a product are more coherent than if the product characteristics were predicted using separate classification schemes and, thus, the resulting item coding is more likely to be accurate. Further, in some examples, the product description includes or is indicative of more coarse-grained or higher-level product characteristics, such as brand (e.g., text extracted from a receipt expressly identifies the brand). Thus, by training the ML model to identify the brand earlier in the product characteristic hierarchy (e.g., first in the hierarchy), subsequent predictions that rely on the previously predicted product characteristic for brand are more likely to be accurate.

In some examples, a product characteristic may not be associated with a particular hierarchy or placement in the order of the hierarchy. For example, the product characteristic “brand” may be associated with several product categories. In a product characteristic hierarchy such as “supergroup, group, module, and brand,” the ML training circuitry 202 trains the ML model to follow a top-down approach in that the ML model is trained to predict the first three product characteristics, namely supergroup, then group, and then module. Accordingly, in the top-down approach, the prediction of the brand by the ML model will be influenced by the predictions of supergroup, group, and module. However, in predicting the brand, the ML model may be less directly influenced by prior predictions as compared to product characteristics such as group and module because other factors may influence the ML model in predicting the brand. For example, the product description may expressly identify the brand (e.g., text extracted from a receipt or image of a product expressly identifies the brand), which is recognized by the ML model. Thus, in some examples, the accuracy of the ML model in predicting the respective product characteristics can be attributable to the influence of prior predictions and/or other factors.

By using the data structures defined in the processed training data 208, the ML training circuitry 202 teaches the ML model (e.g., an autoregressive model such as an LLM) to learn product description language as well as product characteristics and corresponding values for each product description. In particular, the causal property of the ML model (e.g., autoregressive model) provides for consistency in the product characteristic predictions. In some examples disclosed herein, the ML training circuitry 202 trains the ML model without use of general-purpose knowledge; instead, performs causal pretraining to generate a specialized model for item coding tasks (e.g., rather than a multipurpose model). As a result, efficiency in training and/or re-training the pretrained ML model 110 and/or the deployed item coding model 102 is increased, as such re-training can focus on the item coding task(s). Therefore, the example model pretraining circuitry 108 of FIG. 2 generates the specialized pretrained ML model 110 for item coding using less training data and, thus, less computation time for training and/or retraining as compared to multipurpose models that use general-purpose knowledge.

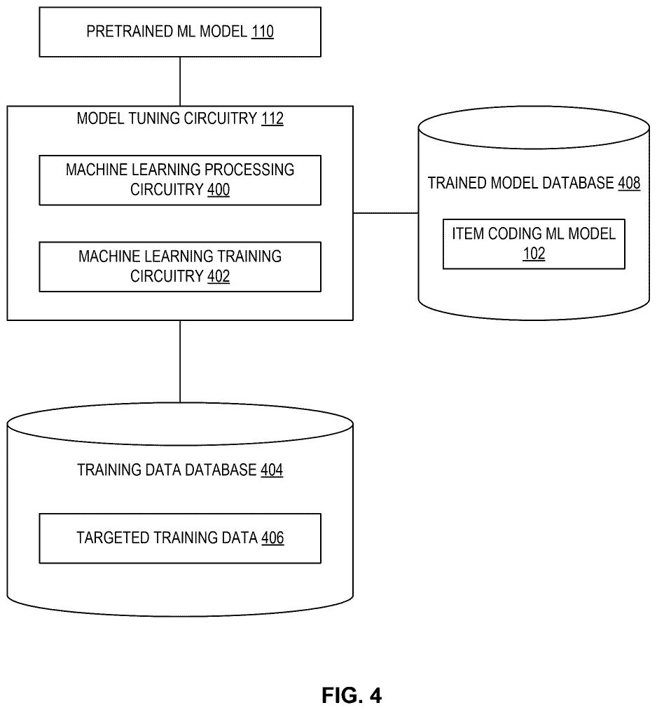

FIG. 4 is a block diagram of an example implementation of the model tuning circuitry 112 of FIG. 1 to tune the pretrained machine learning (ML) model 110 for particular item coding task(s) and/or dataset(s). The model tuning circuitry 112 of FIG. 4 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the model tuning circuitry 112 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

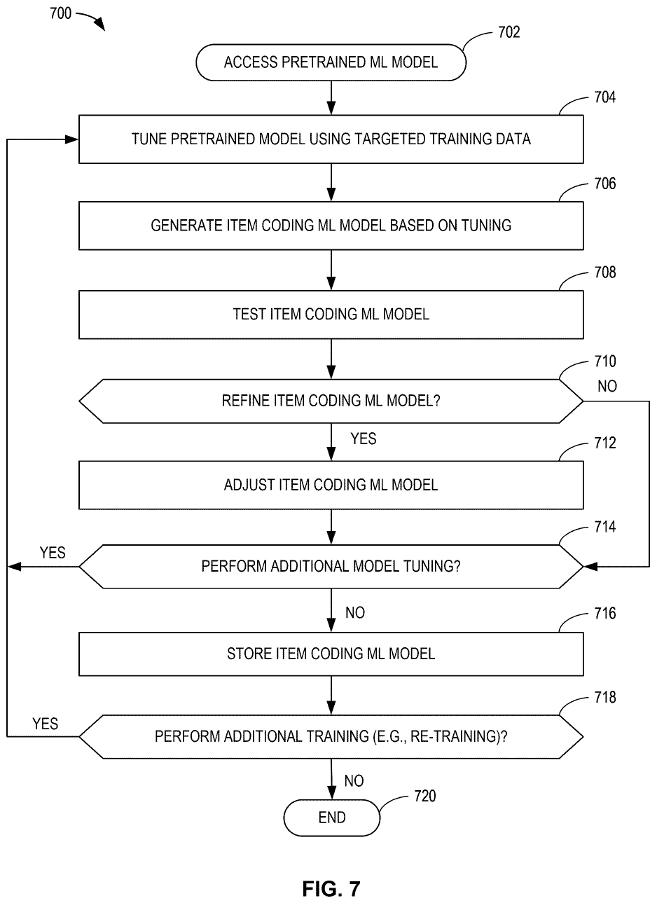

The example model tuning circuitry 112 of FIG. 4 includes machine learning processing circuitry 400 and machine learning training circuitry 402. In some examples, the ML processing circuitry 400 is instantiated by programmable circuitry executing ML processing instructions and/or configured to perform operations such as those represented by the flowchart of FIG. 7. In some examples, the ML training circuitry 402 is instantiated by programmable circuitry executing ML training instructions and/or configured to perform operations such as those represented by the flowchart of FIG. 7.

The model tuning circuitry 112 accesses or otherwise obtains the pretrained ML model 110 (e.g., access or otherwise obtains the pretrained ML model 110 from the pretrained model database 210 of FIG. 2). Also, the model tuning circuitry 112 has access to an example training data database 404 (where the training data database 404 can be local or remote to the model tuning circuitry 112).

In the example of FIG. 4, the model tuning circuitry 112 tunes (e.g., fine-tunes, adjusts, targets) the pretrained ML model 110 by, for example, further training the model 110 using targeted training data 406. The targeted training data 406 can include data for particular products and/or associated product characteristics. For example, while the pretrained ML model 110 is trained (e.g. pretrained) using the processed training data 208 that includes product descriptions and associated item coding product characteristics for many different types of products, the targeted training data 406 can include products and/or item coding product characteristics for a particular retailer. Thus, the targeted training data 406 may be a smaller dataset than the processed training data 208 used in pretraining. In some examples, the ML training circuitry 202 further trains the pretrained ML model 110 using next-token-prediction task(s) based on the targeted training data 406 in a similar as discussed in connection with the example of FIG. 3. In some examples, the targeted training data 406 is labeled with product descriptions and/or product characteristics. In some examples, the targeted training data 406 includes prompts and answers. The example ML training circuitry 402 performs training of the ML pretrained model 110 implemented by the ML processing circuitry 400 using the targeted training data 406.

During the training using the targeted training data 406, parameter(s) and/or weight(s) of the pretrained ML model 110 may be adjusted, scaled, etc. to adapt the ML pretrained model 110 for the intended purpose(s) (e.g., item coding for a particular retailer or manufacturer).

As a result of the tuning by the model tuning circuitry 112, the item coding ML model 102 is generated and stored in a trained model database 408. Prior to deployment, the item coding ML model 102 undergoes a testing phase in which the output(s) of the model 102 (e.g., predicted product characteristics for a given product description) are validated against known data. For example, reference data including product descriptions and known product characteristics can be provided as inputs to the item coding ML model 102. The reference data provided as inputs during the testing phase is different than the reference data used during pretraining and tuning. The output(s) (e.g., predicted product characteristics) generated by the item coding ML model 102 during the testing phase can be compared to the known product characteristics. In some examples, as a result of the testing phase, the trained item coding ML model 102 may be refined to, for example, increase the accuracy and/or sensitivity of the output(s) of the item coding ML model 102 (e.g., by tuning or otherwise adjusting parameter(s) of the model 102). The item coding ML model 102 may then be executed by the item coding circuitry 104.

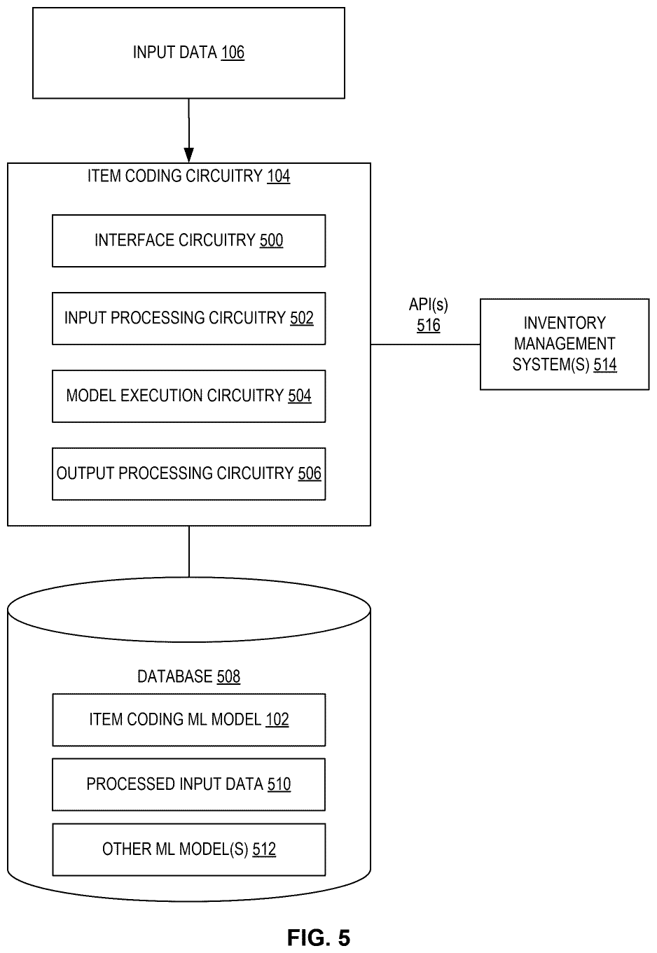

FIG. 5 is a block diagram of an example implementation of the item coding circuitry 104 of FIG. 1 to execute the item coding ML model 102 to perform item coding. The item coding circuitry 104 of FIG. 5 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the item coding circuitry 104 of FIG. 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers.

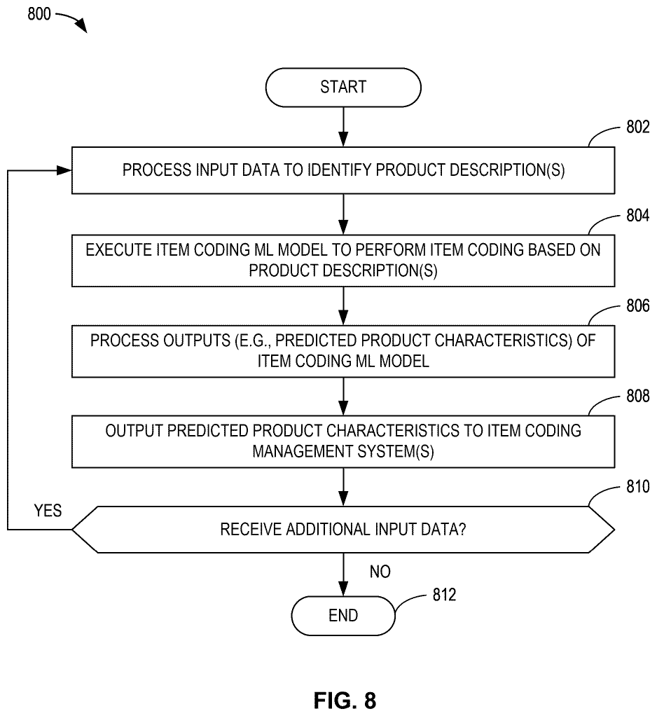

The example item coding circuitry 104 of FIG. 5 includes interface circuitry 500, input processing circuitry 502, model execution circuitry 504, and output processing circuitry 506. In some examples, the interface circuitry 500 is instantiated by programmable circuitry executing interface instructions and/or configured to perform operations such as those represented by the flowchart of FIG. 8. In some examples, the input processing circuitry 502 is instantiated by programmable circuitry executing input processing instructions and/or configured to perform operations such as those represented by the flowchart of FIG. 8. In some examples, the model execution circuitry 504 is instantiated by programmable circuitry executing model execution instructions and/or configured to perform operations such as those represented by the flowchart of FIG. 8. In some examples, the output processing circuitry 506 is instantiated by programmable circuitry executing output processing instructions and/or configured to perform operations such as those represented by the flowchart of FIG. 8.

The interface circuitry 500 of the example item coding circuitry 104 of FIG. 5 accesses or otherwise obtains the item coding ML model 102 (e.g., access or otherwise obtains the item coding ML model 102 from the trained model database 408 of FIG. 4). The item coding ML model 102 can be stored in a database 508 (where the database 508 can be local or remote to the item coding circuitry 104). In some examples, the databases 408, 508 are the same database. Also, in the example of FIG. 5, the interface circuitry 500 accesses, receives, or otherwise obtains the input data 106. The input data 106 can include, for example, image(s) of receipt(s) or image(s) of product(s). The input data 106 can be stored in the database 508.

The input processing circuitry 502 of the example item coding circuitry 104 of FIG. 5 analyzes the input data 106 to, for example, extract text corresponding to product description(s) from image(s) in the input data. For example, the input processing circuitry 502 can use, for example, optical character recognition (OCR) to recognize and/or extract text in the images. The extracted text can be stored in the database 508 as processed input data 510. In some examples, the input processing circuitry 502 executes one or more ML model(s) 512 (i.e., ML model(s) different than the item coding ML model 102) to identify product description(s) in the processed input data 510. The other ML model(s) 512 can include, for example, deep learning model(s) with natural language processing.

The example model execution circuitry 504 of FIG. 5 executes the item coding ML model 102 to perform item coding for the product description(s) in the processed input data 510. As a result of execution of the item coding ML model 102, the model execution circuitry 504 predicts values for the product characteristics associated with the product description(s) (e.g., brand, category, volume). Further, because the item coding ML model 102 is based on the pretrained ML model 110, the item coding ML model 102 generates outputs for product characteristics in a sequence, order, or hierarchy (e.g., predicts the product category before the brand, predicts the brand before the volume).

The example output processing circuitry 506 of FIG. 5 can parse, format, or otherwise process the predicted product characteristics output by the model execution circuitry 504. For example, as a result of execution of the item coding ML model 102 for the product description “Sprite 330 ml,” the model execution circuitry 504 can generate the following raw output:
BRAND: Sprite [SEP] Category: Beverages [SEP] Volume: 330 ml [EOS]
   The output processing circuitry 506 can parse the raw output of the model execution circuitry 504 into, for example, the following data structure that represents a product characteristic hierarchy:
Brand: Sprite
Category: Beverages
Volume: 330 ml.
   The output processing circuitry 506 can generate a dataset or report including the formatted item coding product characteristics corresponding to the outputs of the model execution circuitry 504. Thus, based on execution of the item coding model 102, the item coding circuitry 104 generates product characteristics based on input text corresponding to product descriptions and, thus, provides for natural language processing.

In the example of FIG. 5, the interface circuitry 500 can communicate with, for example, one or more inventory management system(s) 514 associated with, for example, retailer(s), manufacturer(s), etc. The interface circuitry 500 can transmit the dataset(s) and/or report(s) generated by the output processing circuitry 506 to the inventory management system(s) 514 (e.g., via application programming interface(s) (API(s) 516). In some examples, the output processing circuitry 506 formats the outputs of the item coding ML model 102 based on data format(s) and/or data specification(s) of the inventory management system(s) 514 such that the item coding product characteristics predicted by the item coding ML model 102 are integrated into the third-party inventory management system(s) 514.

While an example manner of implementing the model pretraining circuitry 108 of FIG. 1 is illustrated in FIG. 2, one or more of the elements, processes, and/or devices illustrated in FIG. 2 may be combined, divided, re-arranged, omitted, eliminated, and/or implemented in any other way. Further, the example ML processing circuitry 200, the example ML training circuitry 202, and/or, more generally, the example model pretraining circuitry 108 of FIG. 2, may be implemented by hardware alone or by hardware in combination with software and/or firmware. Thus, for example, any of the example ML processing circuitry 200, the example ML training circuitry 202, and/or, more generally, the example model pretraining circuitry 108, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example model pretraining circuitry 108 of FIG. 2 may include one or more elements, processes, and/or devices in addition to, or instead of, those illustrated in FIG. 2, and/or may include more than one of any or all of the illustrated elements, processes and devices.

While an example manner of implementing the model tuning circuitry 112 of FIG. 1 is illustrated in FIG. 4, one or more of the elements, processes, and/or devices illustrated in FIG. 4 may be combined, divided, re-arranged, omitted, eliminated, and/or implemented in any other way. Further, the example ML processing circuitry 400, the example ML training circuitry 402, and/or, more generally, the example model pretraining circuitry 108 of FIG. 4, may be implemented by hardware alone or by hardware in combination with software and/or firmware. Thus, for example, any of the example ML processing circuitry 400, the example ML training circuitry 402, and/or, more generally, the example model tuning circuitry 112, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example model tuning circuitry 112 of FIG. 4 may include one or more elements, processes, and/or devices in addition to, or instead of, those illustrated in FIG. 4, and/or may include more than one of any or all of the illustrated elements, processes and devices.

While an example manner of implementing the item coding circuitry 104 of FIG. 1 is illustrated in FIG. 5, one or more of the elements, processes, and/or devices illustrated in FIG. 5 may be combined, divided, re-arranged, omitted, eliminated, and/or implemented in any other way. Further, the example interface circuitry 500, the example input processing circuitry 502, the example model execution circuitry 504, the example output processing circuitry 506, and/or, more generally, the example item coding circuitry 104 of FIG. 5, may be implemented by hardware alone or by hardware in combination with software and/or firmware. Thus, for example, any of the example interface circuitry 500, the example input processing circuitry 502, the example model execution circuitry 504, the example output processing circuitry 506, and/or, more generally, the example item coding circuitry 104, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example item coding circuitry 104 of FIG. 5 may include one or more elements, processes, and/or devices in addition to, or instead of, those illustrated in FIG. 5, and/or may include more than one of any or all of the illustrated elements, processes and devices.

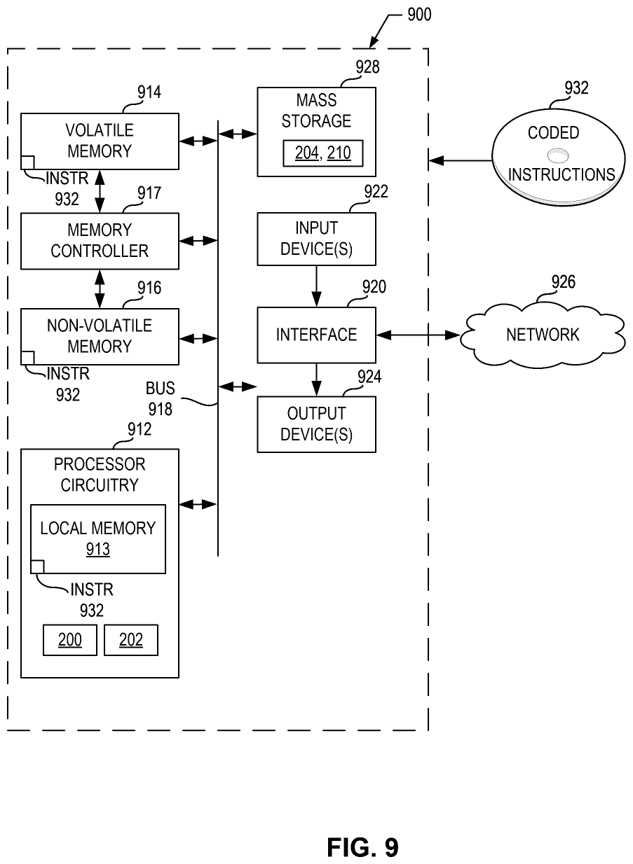

A flowchart representative of example machine readable instructions, which may be executed by programmable circuitry to implement and/or instantiate the model pretraining circuitry 108 of FIG. 2 and/or representative of example operations which may be performed by programmable circuitry to implement and/or instantiate the model pretraining circuitry 108 of FIG. 2, is shown in FIG. 6. A flowchart representative of example machine readable instructions, which may be executed by programmable circuitry to implement and/or instantiate the model tuning circuitry 112 of FIG. 4 and/or representative of example operations which may be performed by programmable circuitry to implement and/or instantiate the model tuning circuitry 112 of FIG. 4, is shown in FIG. 4. A flowchart representative of example machine readable instructions, which may be executed by programmable circuitry to implement and/or instantiate the item coding circuitry 104 of FIG. 5 and/or representative of example operations which may be performed by programmable circuitry to implement and/or instantiate the item coding circuitry 104 of FIG. 5, is shown in FIG. 8. The machine readable instructions may be one or more executable programs or portion(s) of one or more executable programs for execution by programmable circuitry such as the programmable circuitry 912, 1012, 1112 shown in the example respective processor platforms 900, 1000, 1100 discussed below in connection with FIGS. 9, 10, and 11 and/or may be one or more function(s) or portion(s) of functions to be performed by example programmable circuitry (e.g., an FPGA). In some examples, the machine-readable instructions cause an operation, a task, etc., to be carried out and/or performed in an automated manner in the real world. As used herein, “automated” means without human involvement.

The program(s) may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program(s) and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example programs are described with reference to the flowcharts illustrated in FIGS. 6, 7, and 8, many other methods of implementing the example model pretraining circuitry 108, the example model tuning circuitry 112, and/or the example item coding circuitry 104 may alternatively be used. For example, the order of execution of the blocks of the respective flowcharts may be changed, and/or some of the blocks described may be changed, eliminated, or combined. Additionally or alternatively, any or all of the blocks of the respective flowcharts may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 6, 7, and 8 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 6 is a flowchart representative of example machine readable instructions and/or example operations 600 that may be executed, instantiated, and/or performed by programmable circuitry to pretrain a machine learning (ML) model for item coding of product(s) having product description(s) and corresponding item coding product characteristics. The example machine-readable instructions and/or the example operations 600 of FIG. 6 begin at block 602, at which the ML processing circuitry 200 of the example model pretraining circuitry 108 of FIG. 2 processes the training data 206 to generate data structure(s) that define a respective product characteristic hierarchy for corresponding product description(s) (e.g., to generate the processed training data 208 in the form of tokens such as “product_description [SEP] char_name1: char_val1 [SEP] char_name2: char_val2 [SEP] . . . char_name(n): char_val(n) [EOS]”).

At block 604, the ML training circuitry 202 of the example model pretraining circuitry 108 of FIG. 2 trains an ML model (e.g., an autoregressive model) using the processed training data 208 and causal learning. For example, the ML training circuitry 202 can train the ML model to learn a next-token-prediction task to predict product characteristics for item coding.

At block 606, the ML training circuitry 202 can compare the predicted product characteristics by the ML model to the actual product characteristics defined in the processed training data 208. At blocks 608 and 610, the ML training circuitry 202 can adjust (e.g., optimize) the model (e.g., the model parameters) to minimize error between the predicted and actual product characteristics. In some examples, the ML training model uses, for example, a Cross-Entropy loss function to minimize error. When no further training is to be performed (block 612), the ML training circuitry 202 stores the pretrained ML model 110 in the pretrained model database 210 (block 614).

In some examples (block 616), the pretrained ML model 110 undergoes additional training (e.g., re-training) based on, for example, additional and/or updated training data 206, 208. The example instructions 600 end at block 618 when no further training or re-training is to be performed.

FIG. 7 is a flowchart representative of example machine readable instructions and/or example operations 700 that may be executed, instantiated, and/or performed by programmable circuitry to tune the pretrained ML model 110 for item coding. The example machine-readable instructions and/or the example operations 700 of FIG. 7 at which the ML processing circuitry 400 of the example model tuning circuitry 112 of FIG. 4 accesses the pretrained ML model 110 generated by the model pretraining circuitry 108 of FIGS. 1 and/or 2 (e.g., as disclosed in connection with the instructions 600 of FIG. 6). At block 704, the ML training circuitry 402 of the example model tuning circuitry 112 of FIG. 4 tunes (e.g., fine-tunes, further trains) the pretrained ML model 110 using the targeted training data 406. For example, the targeted training data 406 can define particular product descriptions, product characteristics hierarchies, and/or item coding tasks to the processed training data 208 used to pretrain the model 110. At block 706, the ML training circuitry 402 generates the item coding ML model 102 as a result of the tuning.

At block 708, the ML training circuitry 402 tests the item coding ML model 102 using, for example, training data including product descriptions and product characteristics that were not used during pretraining (e.g., block 604 of FIG. 6) and/or the training at block 704. In some examples, the ML training circuitry 402 adjusts the item coding ML model 102 based on the testing phase (block 712). When no further tuning of the model 102 is to be performed (block 714), the ML training circuitry 402 stores the item coding ML model 102 in the trained model database 408 (block 716).

In some examples (block 718), the pretrained ML model 110 undergoes additional training (e.g., re-training) based on, for example, additional and/or updated targeted training data 406. The example instructions 700 end at block 720 when no further training or re-training is to be performed.

FIG. 8 is a flowchart representative of example machine readable instructions and/or example operations 800 that may be executed, instantiated, and/or performed by programmable circuitry to execute the item coding ML model 102 to perform item coding of product(s) based on product description(s). The example machine-readable instructions and/or the example operations 800 of FIG. 8 begin at block 802 at which the input processing circuitry 502 of the example item coding circuitry 104 of FIG. 5 processes the input data 106 to identify product description(s) in the input data 106. For example, the input processing circuitry 502 can execute the ML model(s) 512 (e.g., deep learning model(s)) to recognize text in, for example, image(s) of receipt(s) or image(s) of product(s) indicative of product description(s).

At block 804, the model execution circuitry 504 of the example item coding circuitry 104 of FIG. 5 executes the item coding ML model 102 to perform item coding based on the product description(s) (e.g., the processed input data 510). As result of execution of the item coding ML model 102, the model execution circuitry 504 outputs predicted product characteristics (e.g., predicts values such as a brand, a product category, and a volume) of product(s) associated with the product description(s). At block 806, the output processing circuitry 506 of the example item coding circuitry 104 of FIG. 5 processes the predicted product characteristics output by the item coding ML model 102. For example, the output processing circuitry 506 can parse the raw outputs of the item coding ML model 102 into a data structure that identifies the product characteristic and corresponding value. At block 808, the interface circuitry 500 of the example item coding circuitry 104 of FIG. 5 outputs the predicted product characteristics to one or more item coding management systems 514 (e.g., via API(s) 516). The example instructions 800 end when no further input data is received (blocks 810, 812).

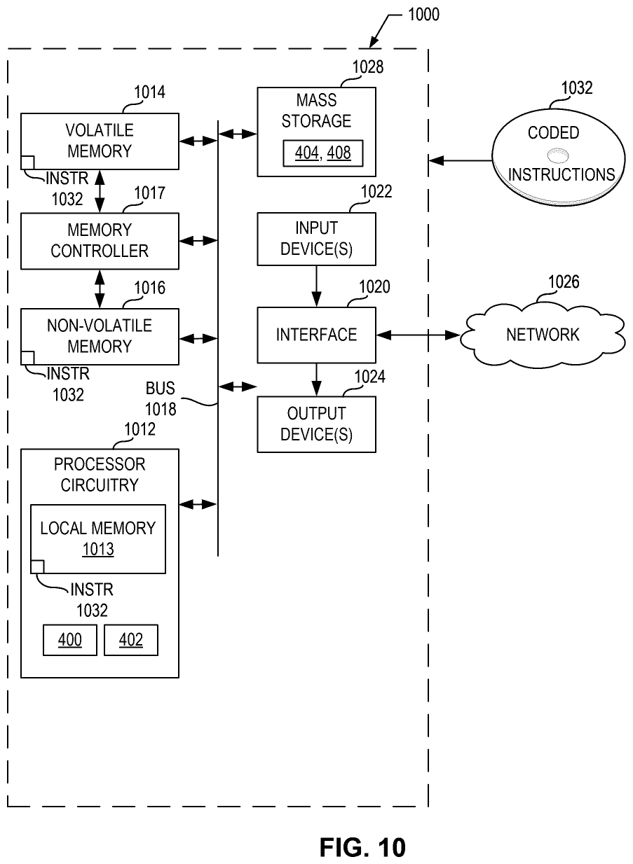

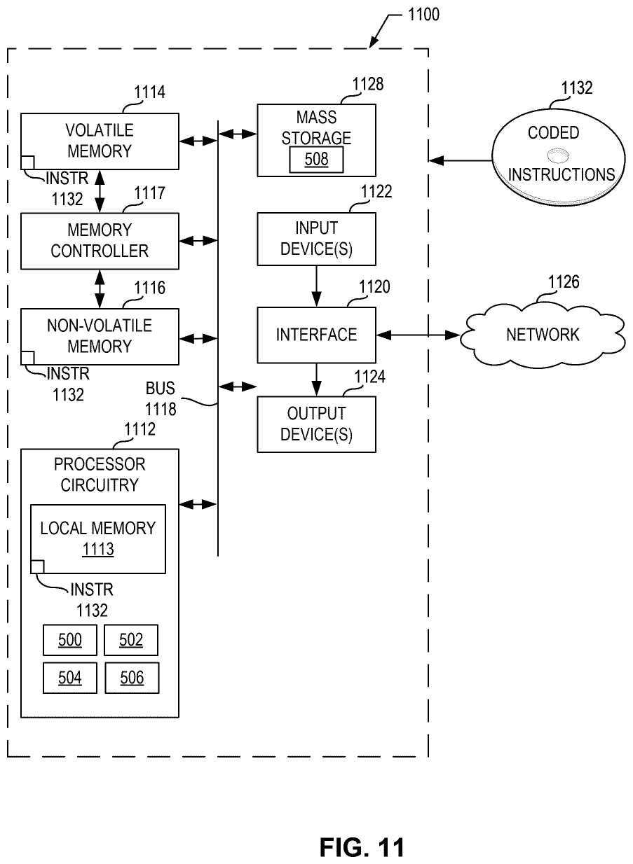

FIG. 9 is a block diagram of an example programmable circuitry platform 900 structured to execute and/or instantiate the example machine-readable instructions and/or the example operations of FIG. 6 to implement the model pretraining circuitry 108 of FIG. 2. FIG. 10 is a block diagram of an example programmable circuitry platform 1000 structured to execute and/or instantiate the example machine-readable instructions and/or the example operations of FIG. 7 to implement the model tuning circuitry 112 of FIG. 4. FIG. 11 is a block diagram of an example programmable circuitry platform 1100 structured to execute and/or instantiate the example machine-readable instructions and/or the example operations of FIG. 8 to implement the item coding circuitry 104 of FIG. 5. The programmable circuitry platform 900, 1000, 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 900, 1000, 1100 of the illustrated example includes programmable circuitry 912, 1012, 1112. The programmable circuitry 912, 1012, 1112 of the illustrated example is hardware. For example, the programmable circuitry 912, 1012, 1112 can be implemented by one or more integrated circuits, logic circuits, FPGAs, microprocessors, CPUs, GPUs, VPUs, DSPs, and/or microcontrollers from any desired family or manufacturer. The programmable circuitry 912, 1012, 1112 may be implemented by one or more semiconductor based (e.g., silicon based) devices. In the example of FIG. 9, the programmable circuitry 912 implements the machine learning (ML) processing circuitry 200 and the ML training circuitry 202 of the example model pretraining circuitry 108 of FIG. 2. In the example of FIG. 10, the programmable circuitry 1012 implements the ML processing circuitry 400 and the ML training circuitry 402 of the example model tuning circuitry 112 of FIG. 4. In the example of FIG. 11, the programmable circuitry 1112 implements the interface circuitry 500, the input processing circuitry 502, the model execution circuitry 504, and the output processing circuitry 506 of the example item coding circuitry 102 of FIG. 5.

The programmable circuitry 912, 1012, 1112 of the illustrated example includes a local memory 913, 1013, 1113 (e.g., a cache, registers, etc.). The programmable circuitry 912, 1012, 1112 of the illustrated example is in communication with main memory 914, 1014, 1114; 916, 1016, 1116, which includes a volatile memory 914, 1014, 1114 and a non-volatile memory 916, 1016, 1116, by a bus 918, 1018, 1118. The volatile memory 914, 1014, 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916, 1016, 1116 may be implemented by flash memory and/or any other desired type of memory device. Access to the main memory 914, 1014, 1114; 916, 1016, 1116 of the illustrated example is controlled by a memory controller 917, 1017, 1117. In some examples, the memory controller 917, 1017, 1117 may be implemented by one or more integrated circuits, logic circuits, microcontrollers from any desired family or manufacturer, or any other type of circuitry to manage the flow of data going to and from the main memory 914, 1014, 1114; 916, 1016, 1116.

The programmable circuitry platform 900, 1000, 1100 of the illustrated example also includes interface circuitry 920, 1020, 1120. The interface circuitry 920, 1020, 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922, 1022, 1122 are connected to the interface circuitry 920, 1020, 1120. The input device(s) 922, 1022, 1122 permit(s) a user (e.g., a human user, a machine user, etc.) to enter data and/or commands into the programmable circuitry 912, 1012, 1112. The input device(s) 922, 1022, 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924, 1024, 1124 are also connected to the interface circuitry 920, 1020, 1120 of the illustrated example. The output device(s) 924, 1024, 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920, 1020, 1120 of the illustrated example, thus, typically includes a graphics driver card, a graphics driver chip, and/or graphics processor circuitry such as a GPU.

The interface circuitry 920, 1020, 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926, 1026, 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900, 1000, 1100 of the illustrated example also includes one or more mass storage discs or devices 928, 1028, 1128 to store firmware, software, and/or data. Examples of such mass storage discs or devices 928, 1028, 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 932, 1032, 1132 which may be implemented by the machine readable instructions of FIGS. 6, 7, 8, may be stored in the mass storage device 928, 1028, 1128, in the volatile memory 914, 1014, 1114 in the non-volatile memory 916, 1016, 1116 and/or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that pretrain a machine learning (ML) model to improve accuracy of automated item coding of products. Example disclosed herein train the ML model to account for sequential dependencies with respect to product characteristic hierarchies. As a result, examples disclosed herein generate a ML model that predicts item coding product characteristics for a given product description with increased accuracy and coherency with respect to product characteristics assigned to a product. Rather than using multiple classifiers to separately predict product characteristics, examples disclosed herein provide for a ML model that leverages causal training to predict product characteristics. As a result, examples disclosed herein provide improvements with respect to training and maintaining the ML model and efficient use of compute resources as compared to use of separate classifiers.

Example systems and apparatus to train machine learning models for item coding are disclosed herein. Further examples and combinations thereof include the following:

Example 1 includes an apparatus to pretrain a machine learning model for item coding, the apparatus including machine-readable instructions; and at least one programmable circuit to at least one of instantiate or execute the machine-readable instructions to generate a data structure based on a product description, the data structure defining a hierarchy of product characteristics; train a machine learning (ML) model based on the data structure and using causal training; and generate, based on the causal training, a pre-trained ML model to output predicted product characteristics for item coding.

Example 2 includes any preceding clause(s) of Example 1, wherein one or more of the at least one programmable circuit is to train the ML model based on a next-token-prediction task.

Example 3 includes any preceding clause(s) of any one or more of Examples 1 or 2, wherein the product description corresponds to a first token, a first product characteristic of the hierarchy corresponds to a second token, and a second product characteristic of the hierarchy corresponds to a third token.

Example 4 includes any preceding clause(s) of any one or more of Examples 1-3, wherein the second token serves as an input token, the one or more of the at least one programmable circuit to train the ML model to predict the second product characteristic based on the input token.

Example 5 includes any preceding clause(s) of any one or more of Examples 1-4, wherein the ML model is an autoregressive model.

Example 6 includes any preceding clause(s) of any one or more of Examples 1-5, wherein one or more of the at least one programmable circuit is to train the ML model to predict, based on the product description, a first product characteristic; and predict, based on the first product characteristic, a second product characteristic, the second product characteristic later in the hierarchy than the first product characteristic.

Example 7 includes any preceding clause(s) of any one or more of Examples 1-6, wherein the first product characteristic is a brand of a product and the second product characteristic is a volume of the product.

Example 8 includes a non-transitory machine-readable storage medium including machine-readable instructions to cause at least one programmable circuit to at least generate a token data structure based on a product description, the token data structure defining input tokens corresponding to respective product characteristics, the input tokens defined in a product characteristic sequence; train a machine learning (ML) model based on the token data structure and a next-prediction-token task; and generate, based on the training, a pre-trained ML model to output predicted product characteristics for item coding.

Example 9 includes any preceding clause(s) of Example 8, wherein the ML model is an autoregressive model.

Example 10 includes any preceding clause(s) of any one or more of Examples 8 or 9, wherein the machine-readable instructions are to cause one or more of the at least one programmable circuit to train the ML model to predict, a first product characteristic, the first product characteristic corresponding to a first input token of the input tokens; and predict, based on the first input token, a second product characteristic, the second product characteristic later in the product characteristic sequence than the first product characteristic.

Example 11 includes any preceding clause(s) of any one or more of Examples 8-10, wherein the machine-readable instructions are to cause one or more of the at least one programmable circuit to execute a Cross-Entropy loss function responsive to the training of the ML model; and adjust the trained ML model to generate the pre-trained ML model.

Example 12 includes any preceding clause(s) of any one or more of Examples 8-11, wherein the token data structure is first training data and the machine-readable instructions are to cause one or more of the at least one programmable circuit to tune the pre-trained ML model based on second training data.

Example 13 includes an apparatus including interface circuitry; machine-readable instructions; and at least one programmable circuit to at least one of instantiate or execute the machine-readable instructions to execute a first machine learning (ML) model to recognize text in an image, the text corresponding to a product description of a product; execute a second ML model to predict product characteristics for the product, the second ML model based on a pretrained model, the pretrained model trained for an item coding task; and output, based on the execution of the second ML model, the predicted product characteristics, the predicted product characteristics defining a product characteristic hierarchy.

Example 14 includes any preceding clause(s) of Example 13, wherein the image is of a receipt.

Example 15 includes any preceding clause(s) of any one or more of Examples 13 or 14, wherein the image is of the product.

Example 16 includes any preceding clause(s) of any one or more of Examples 13-15, wherein the second ML model is an autoregressive model.

Example 17 includes any preceding clause(s) of any one or more of Examples 13-16, wherein the pretrained model is tuned to generate the second ML model.

Example 18 includes any preceding clause(s) of any one or more of Examples 13-17, wherein the second ML model is to generate first outputs and one or more of the at least one programmable circuit is to parse the first outputs, the predicted product characteristics corresponding to the parsed first outputs.

Example 19 includes any preceding clause(s) of any one or more of Examples 13-18, wherein one or more of the at least one programmable circuit is to output the predicted product characteristics via an application programming interface.

Example 20 includes any preceding clause(s) of any one or more of Examples 13-19, wherein the product characteristic hierarchy includes a first product characteristic and a second product characteristic, one or more of the at least one programmable circuit to execute the second ML model to predict the first product characteristic and predict the second product characteristic based on the predicted first product characteristic.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to pretrain a machine learning model for item coding, the apparatus comprising:
machine-readable instructions; and
at least one programmable circuit to at least one of instantiate or execute the machine-readable instructions to:
generate a data structure based on a product description, the data structure defining a hierarchy of product characteristics;
train a machine learning (ML) model based on the data structure and using causal training; and
generate, based on the causal training, a pre-trained ML model to output predicted product characteristics for item coding.

2. The apparatus of claim 1, wherein one or more of the at least one programmable circuit is to train the ML model based on a next-token-prediction task.

3. The apparatus of claim 1, wherein the product description corresponds to a first token, a first product characteristic of the hierarchy corresponds to a second token, and a second product characteristic of the hierarchy corresponds to a third token.

4. The apparatus of claim 3, wherein the second token serves as an input token, the one or more of the at least one programmable circuit to train the ML model to predict the second product characteristic based on the input token.

5. The apparatus of claim 1, wherein the ML model is an autoregressive model.

6. The apparatus of claim 1, wherein one or more of the at least one programmable circuit is to train the ML model to:
predict, based on the product description, a first product characteristic; and
predict, based on the first product characteristic, a second product characteristic, the second product characteristic later in the hierarchy than the first product characteristic.

7. The apparatus of claim 6, wherein the first product characteristic is a brand of a product and the second product characteristic is a volume of the product.

8. A non-transitory machine-readable storage medium comprising machine-readable instructions to cause at least one programmable circuit to at least:
generate a token data structure based on a product description, the token data structure defining input tokens corresponding to respective product characteristics, the input tokens defined in a product characteristic sequence;
train a machine learning (ML) model based on the token data structure and a next-prediction-token task; and
generate, based on the training, a pre-trained ML model to output predicted product characteristics for item coding.

9. The non-transitory machine-readable storage medium of claim 8, wherein the ML model is an autoregressive model.

10. The non-transitory machine-readable storage medium of claim 8, wherein the machine-readable instructions are to cause one or more of the at least one programmable circuit to train the ML model to:
predict, a first product characteristic, the first product characteristic corresponding to a first input token of the input tokens; and
predict, based on the first input token, a second product characteristic, the second product characteristic later in the product characteristic sequence than the first product characteristic.

11. The non-transitory machine-readable storage medium of claim 8, wherein the machine-readable instructions are to cause one or more of the at least one programmable circuit to:
execute a Cross-Entropy loss function responsive to the training of the ML model; and
adjust the trained ML model to generate the pre-trained ML model.

12. The non-transitory machine-readable storage medium of claim 8, wherein the token data structure is first training data and the machine-readable instructions are to cause one or more of the at least one programmable circuit to tune the pre-trained ML model based on second training data.

13. An apparatus comprising:
interface circuitry;
machine-readable instructions; and
at least one programmable circuit to at least one of instantiate or execute the machine-readable instructions to:
execute a first machine learning (ML) model to recognize text in an image, the text corresponding to a product description of a product;
execute a second ML model to predict product characteristics for the product, the second ML model based on a pretrained model, the pretrained model trained for an item coding task; and
output, based on the execution of the second ML model, the predicted product characteristics, the predicted product characteristics defining a product characteristic hierarchy.

14. The apparatus of claim 13, wherein the image is of a receipt.

15. The apparatus of claim 13, wherein the image is of the product.

16. The apparatus of claim 13, wherein the second ML model is an autoregressive model.

17. The apparatus of claim 13, wherein the pretrained model is tuned to generate the second ML model.

18. The apparatus of claim 13, wherein the second ML model is to generate first outputs and one or more of the at least one programmable circuit is to parse the first outputs, the predicted product characteristics corresponding to the parsed first outputs.

19. The apparatus of claim 13, wherein one or more of the at least one programmable circuit is to output the predicted product characteristics via an application programming interface.

20. The apparatus of claim 13, wherein the product characteristic hierarchy includes a first product characteristic and a second product characteristic, one or more of the at least one programmable circuit to execute the second ML model to predict the first product characteristic and predict the second product characteristic based on the predicted first product characteristic.
